(19) United States
(12) Patent Application Publication
(10) Pub. No.: US 2025/0014398 A1
(43) Pub. Date: Jan. 9, 2025

(54) VEHICLE INFORMATION MANAGEMENT SYSTEM

(71) Applicant: Niterra Co., Ltd., Nagoya-shi, Aichi (JP)

(72) Inventors: Sei KAWAMOTO, Nagoya-shi (JP); Tatsuo SASAKI, Nagoya-shi (JP); Akio NISHIKAWA, Nagoya-shi (JP); Takanori HORIGUCHI, Nagoya-shi (JP); Ryosuke OCHIAI, Nagoya-shi (JP)

(21) Appl. No.: 18/712,355

(22) PCT Filed: Nov. 22, 2022
(86) PCT No.: PCT/JP2022/043248

§ 371 Date: May 22, 2024

(30) Foreign Application Priority Data
Nov. 25, 2021 (JP) 2021-191007

(51) Int. Cl. G07C 5/08; G07C 5/00; H04W 4/44

(52) U.S. Cl. CPC G07C 5/0808; G07C 5/008; H04W 4/44

(57) ABSTRACT

The vehicle information management system (100) includes: an acquisition device (20) configured to acquire vehicle information from a vehicle; a server (30); and an application program (48A) (relay means) provided in a portable terminal (40). The acquisition device (20) includes a correction unit (22C) which, every time a predetermined condition set in advance is satisfied, in a state where a first communication unit (24) is communication-connected with a second communication unit (42), acquires at least one of reference time information acquired by a reference time acquisition unit (41A) and time information of a second clock unit (41B), and corrects time information of the first clock unit (22B) on the basis of the acquired time information.

### TECHNICAL FIELD

The present invention relates a vehicle information management system.

### BACKGROUND ART

Patent Document 1 discloses a vehicle diagnosis system for appropriately performing vehicle diagnosis assistance for a person with less knowledge about a vehicle. The vehicle diagnosis system in Patent Document 1 collects various vehicle information indicating the state of the vehicle from a control device of the vehicle, by an acquisition device (adapter), and accumulates the vehicle information in a server device via a portable terminal device.

### PRIOR ART DOCUMENT

### Patent Document

Patent Document 1: Japanese Patent Application Laid-Open (kokai) No. 2019-27816

### SUMMARY OF THE INVENTION

### Problem to be Solved by the Invention

The vehicle information accumulated in the server device is used for, for example, grasping a timing of changing parts of the vehicle, the lifestyle of a driver, and the like. In such usage, it is important to be able to accurately specify the time when the vehicle information is acquired. Accordingly, it is conceivable that a clock is provided in the acquisition device and the time when the vehicle information is acquired is recorded. However, in this configuration, there is a concern that, as time elapses, the time of the clock provided in the acquisition device may deviate, and accordingly, information recorded as the time when the vehicle information is acquired also may deviate.

The present invention has been made to solve at least one of the above problems, and an object of the present invention is to provide a vehicle information management system that can more accurately specify the time when an acquisition device has acquired vehicle information.

### Means for Solving the Problem

A vehicle information management system according to one aspect of the present invention includes: an acquisition device including an acquisition unit configured to acquire first vehicle information indicating a state of a vehicle, from the vehicle, a first clock unit, a storage unit configured to store the first vehicle information acquired by the acquisition unit, as second vehicle information, in association with time information of the first clock unit, and a first communication unit configured to transmit the second vehicle information stored in the storage unit, to outside; a server; and relay means provided in a portable terminal having a second communication unit, the relay means being configured to, when the second communication unit has acquired the second vehicle information transmitted by the first communication unit, cause the portable terminal to perform operation of transmitting the second vehicle information to the server. The portable terminal includes a reference time acquisition unit configured to acquire reference time information, and a second clock unit of which time information is corrected on the basis of the reference time information acquired by the reference time acquisition unit. The acquisition device includes a correction unit configured to, every time a predetermined condition set in advance is satisfied, in a state where the first communication unit is communication-connected with the second communication unit, acquire at least one of the reference time information acquired by the reference time acquisition unit and the time information of the second clock unit, and correct the time information of the first clock unit on the basis of acquired time information.

The acquisition device of the above vehicle information management system acquires, every time the predetermined condition set in advance is satisfied, in a state where the first communication unit is communication-connected with the second communication unit, at least one of the reference time information and the time information of the second clock unit, and corrects the time information of the first clock unit on the basis of the acquired time information. Thus, the acquisition device can store the first vehicle information acquired from the vehicle, as the second vehicle information, in association with the corrected time information of the first clock unit. Therefore, the vehicle information management system can more accurately specify the time when the acquisition device has acquired the first vehicle information.

A control method according to one aspect of the present disclosure includes: an acquisition step of causing an acquisition device to acquire first vehicle information indicating a state of a vehicle, from the vehicle; a storage step of causing the acquisition device to store the first vehicle information acquired in the acquisition step, as second vehicle information, in association with time information of a first clock unit included in the acquisition device; a transmission step of transmitting the second vehicle information stored in the storage step, to outside of the acquisition device; a relay step of causing a server to receive, via a portable terminal, the second vehicle information transmitted in the transmission step; and a correction step of, every time a predetermined condition set in advance is satisfied, in a state where the acquisition device is communication-connected with the portable terminal, causing the acquisition device to acquire at least one of a reference time information acquired by the portable terminal and time information of a second clock unit included in the portable terminal, which has been corrected on the basis of the reference time information, and correcting the time information of the first clock unit.

### Advantageous Effects of the Invention

The present invention makes it possible to provide a vehicle information management system that can more accurately specify the time when an acquisition device has acquired vehicle information.

### BRIEF DESCRIPTION OF THE DRAWINGS

FIG. 1 is a block diagram conceptually exemplifying the configurations of a vehicle information management system of the first embodiment, and a vehicle and the like to which the vehicle information management system is applied.

### MODES FOR CARRYING OUT THE INVENTION

### 1. First Embodiment

### 1-1. Configuration of Vehicle Information Management System 100

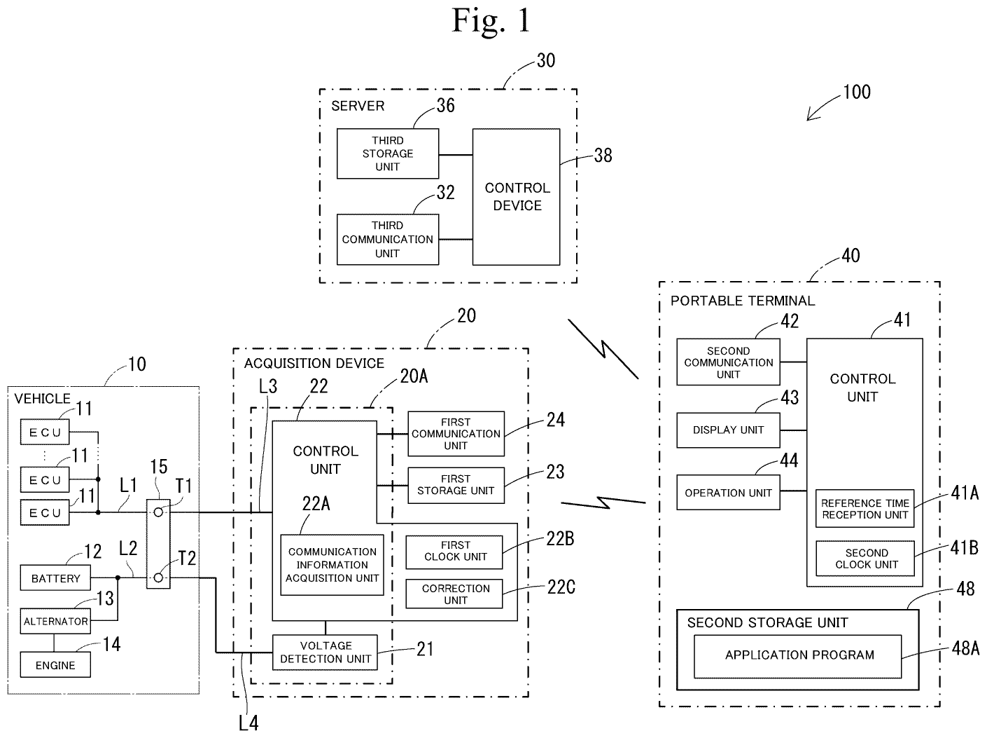

A vehicle information management system 100 shown in FIG. 1 is a system for managing information about a vehicle 10. The vehicle information management system 100 mainly includes an acquisition device 20, a server 30, and an application program 48A included in a portable terminal 40.

The vehicle 10 to which the vehicle information management system 100 is applied is an engine vehicle driven by a gasoline engine, for example. The vehicle 10 mainly includes an electronic control device 11, a battery 12, an alternator 13, an engine 14, a connector 15, a communication line L1, a power line L2, and the like.

The electronic control device 11 is a device for controlling equipment mounted on the vehicle 10. A plurality of the electronic control devices 11 are provided. Each electronic control device 11 is, for example, a known ECU (Electronic Control Unit). In FIG. 1, each electronic control device 11 is denoted as “ECU”. The battery 12 is, for example, a vehicular battery such as a lead battery. The alternator 13 is a known alternator that generates electricity by being driven by the engine 14.

The connector 15 is a connector that can output first vehicle information indicating the state of the vehicle 10 in conformity with a communication standard of OBD2 (On Board Diagnosis second generation). The connector 15 includes a first terminal T1 and a second terminal T2. The communication line L1 is electrically connected to the first terminal T1. The communication line L1 is, for example, a CAN (Controller Area Network) communication bus. The communication line L1 is electrically connected to each of the electronic control devices 11. Information that is transmitted/received by each electronic control device 11 flows through the communication line L1.

The power line L2 is electrically connected to the second terminal T2. The power line L2 is connected to each of the battery 12 and the alternator 13. Output voltage of the battery 12 and output voltage of the alternator 13 are applied on the power line L2. In a state where the alternator 13 is not driven, only output voltage of the battery 12, of the battery 12 and the alternator 13, is applied on the power line L2. Output voltage of the battery 12 in a full-charge state is greater than 0 V, and is, for example, 12 V. In a state where the alternator 13 is driven, the higher one of output voltages of the battery 12 and the alternator 13 is applied on the power line L2. In a state where the alternator 13 is driven, voltage applied on the power line L2 is, for example, 14 V at maximum.

The acquisition device 20 is a device that functions as a vehicle information acquisition device. The acquisition device 20 is mounted in the vehicle 10 in a state where the acquisition device 20 is continuously connected to the above connector 15. The acquisition device 20 mainly includes an acquisition unit 20A, a first clock unit 22B, a first storage unit 23, and a first communication unit 24.

The acquisition unit 20A has a function of acquiring the first vehicle information indicating the state of the vehicle 10, from the vehicle 10. The first storage unit 23 has a function of storing the first vehicle information acquired by the acquisition unit 20A, as second vehicle information, in association with the time of the first clock unit 22B. The first communication unit 24 has a function of transmitting the second vehicle information stored in the first storage unit 23, to the outside.

The acquisition unit 20A includes a first connection line L3, a second connection line L4, a voltage detection unit 21, and a communication information acquisition unit 22A. The acquisition unit 20A is connected to the connector 15 of the vehicle 10 and can acquire the first vehicle information from the vehicle 10. The acquisition unit 20A has a connector (not shown) including terminals at ends of the first connection line L3 and the second connection line L4, and this connector is attached to the connector 15. Then, the acquisition unit 20A acquires, from the vehicle 10, the first vehicle information indicating the state of the vehicle 10 by wired communication via the first connection line L3 and the second connection line L4. For example, in a case where the connector (not shown) of the acquisition unit 20A is connected to the connector 15, the first connection line L3 is electrically connected to the first terminal T1 of the connector 15. That is, the first connection line L3 is electrically connected to the communication line L1 via the first terminal T1. As a result, information that is transmitted/received by each electronic control device 11 flows through the first connection line L3.

In addition, in a case where the acquisition device 20 is connected to the connector 15, the second connection line L4 is electrically connected to the second terminal T2 of the connector 15. That is, the second connection line L4 is electrically connected to the power line L2 via the second terminal T2. As a result, voltage applied on the power line L2, i.e., the higher one of output voltage of the battery 12 and output voltage of the alternator 13, is applied on the second connection line L4.

The voltage detection unit 21 is configured as a known voltage detection circuit, for example. The voltage detection unit 21 detects voltage of the second connection line L4 as voltage of the power line L2. The first vehicle information that the acquisition unit 20A acquires includes information that the voltage detection unit 21 can acquire from the second connection line L4 (e.g., battery voltage).

The communication information acquisition unit 22A is configured as a part of a control unit 22 included in the acquisition device 20. The control unit 22 is configured by an information processing device such as an MCU (Micro Controller Unit), for example. The control unit 22 has a CPU, a ROM, a RAM, and the like, and controls operation of the acquisition device 20. The control unit 22 is connected to the first connection line L3 and can communicate with each electronic control device 11 via the first connection line L3. By transmitting a request signal to the electronic control device 11, the communication information acquisition unit 22A can acquire the first vehicle information according to the request signal, from the electronic control device 11. The first vehicle information that the communication information acquisition unit 22A can acquire by a request signal includes, for example, a vehicle speed, an MIL (Malfunction Indication Lamp) state, an engine rotation speed, and the like. In addition, a value detected by the voltage detection unit 21 is inputted to the control unit 22.

The first clock unit 22B is configured as a part of the control unit 22 described above. For example, in a case where a time is set by an operation unit provided in the acquisition device 20, the first clock unit 22B performs clocking from the set time. The time information of the first clock unit 22B is information indicating UNIX (registered trademark) time, for example.

The first storage unit 23 corresponds to an example of a “storage unit”. The first storage unit 23 has known storage means such as a semiconductor memory and can store various information.

The first communication unit 24 is a communication interface for performing wireless communication (more specifically, near field communication) with an external device such as the portable terminal 40 by a known wireless communication method. The first communication unit 24 performs wireless communication with the portable terminal 40 in conformity with a wireless communication standard of Bluetooth (registered trademark) communication, for example.

The portable terminal 40 is configured as a known portable information processing terminal such as a smartphone or a tablet terminal, for example. The portable terminal 40 includes a control unit 41, a second communication unit 42, a display unit 43, an operation unit 44, a second storage unit 48, and the like.

The control unit 41 is configured as an information processing device such as an MCU (Micro Controller Unit), for example. The control unit 41 includes a CPU (Central Processing Unit), a ROM, a RAM, and the like, and controls operation of the portable terminal 40. The control unit 41 can perform control in accordance with an application program 48A described later.

The control unit 41 includes a reference time acquisition unit 41A and a second clock unit 41B. The reference time acquisition unit 41A acquires reference time information from the outside via the second communication unit 42. The reference time information is information indicating UNIX (registered trademark) time, for example. Every time an acquisition condition set in advance is satisfied, the reference time acquisition unit 41A performs processing of acquiring the reference time information. The acquisition condition is, for example, a condition that can be satisfied cyclically. The acquisition condition is, for example, that a certain period elapses from when the reference time information has been acquired at the last time. As processing of acquiring the reference time information, the reference time acquisition unit 41A communicates with a base station located near the portable terminal 40, to acquire the reference time information. The second clock unit 41B corrects time information of the second clock unit 41B on the basis of the reference time information acquired by the reference time acquisition unit 41A. The time information of the second clock unit 41B is information indicating UNIX (registered trademark) time, for example.

The second communication unit 42 is a communication device that can perform wired communication and wireless communication by a known communication method. It suffices that the second communication unit 42 is configured to be capable of communicating with the acquisition device 20 and capable of communicating with the server 30. In the representative example, the second communication unit 42 can perform wireless communication with the first communication unit 24 of the acquisition device 20 by Bluetooth (registered trademark) communication. Further, in the representative example, the second communication unit 42 can communicate with the server 30 or another external device by accessing the Internet directly or via an external device by a communication method conforming to a known wireless communication standard such as Wi-Fi (registered trademark), LTE (Long Term Evolution), the fourth-generation mobile communication system, or the fifth-generation mobile communication system.

The display unit 43 is a known display capable of displaying various images such as letters and pictures. The operation unit 44 is an input interface that allows input of information. In the representative example, the display unit 43 and the operation unit 44 form a touch panel.

The second storage unit 48 has known storage means such as a semiconductor memory and can store various information. In the second storage unit 48, at least the application program 48A is stored. The application program 48A corresponds to an example of relay means and can cause the portable terminal 40 to perform various operations.

The server 30 is a management device having a function of accumulating information and a function of managing information. The server 30 is an information processing device having an information processing function, and is configured by, for example, a computer and the like. The server 30 mainly includes a third communication unit 32, a third storage unit 36, a control device 38, and the like. The server 30 may be provided with an operation unit having an input device such as a mouse or a keyboard, a display unit having an output device such as a display, and the like.

The control device 38 is configured as, for example, an information processing device having a CPU, ROM, RAM, and the like. The control device 38 has a function of performing various calculations and controls, and a function of controlling operation of the server 30.

The third communication unit 32 is a communication device that can perform wireless communication and wired communication by known methods. In the representative example, the third communication unit 32 can communicate with the portable terminal 40 or another external device by accessing the Internet directly or via an external device by a communication method conforming to a known wireless communication standard such as Wi-Fi, LTE, the fourth-generation mobile communication system, or the fifth-generation mobile communication system. The third communication unit 32 has a function of receiving the second vehicle information from the portable terminal 40.

The third storage unit 36 has a function of accumulating second vehicle information received by the third communication unit 32. The third storage unit 36 accumulates the second vehicle information transmitted from the portable terminal 40. The server 30 transmits the second vehicle information accumulated in the third storage unit 36, in response to a request from the portable terminal 40 or another terminal device.

The above acquisition device 20 further includes a correction unit 22C. The correction unit 22C is configured as a part of the control unit 22. Every time a predetermined condition set in advance is satisfied, in a state where the first communication unit 24 is communication-connected with the second communication unit 42, the correction unit 22C acquires at least one of the reference time information acquired by the reference time acquisition unit 41A and the time information of the second clock unit 41B, and corrects the time information of the first clock unit 22B on the basis of the acquired time information.

Setting of the predetermined condition may be allowed to be charged or may not be allowed to be changed. The predetermined condition is, for example, a condition that can be satisfied cyclically. In the present embodiment, the predetermined condition is that “the first communication unit 24 is communication-connected with the second communication unit 42 a predetermined number of times”. The predetermined number of times is one in the present embodiment, but may be two or more.

### 1-2. Operation of Vehicle Information Management System 100

In a state where the vehicle 10 is not started, the acquisition device 20 determines whether or not the vehicle 10 is started. The determination for whether or not the vehicle 10 is started is performed on the basis of the first vehicle information, for example. Specifically, when the voltage (battery voltage) of the second connection line L4 has exceeded a first threshold voltage from a state of being equal to or lower than the first threshold voltage, it is determined that the vehicle 10 is started. As another example, when communication is restored on the first connection line L3 from a communication stopped state, it is determined that the vehicle 10 is started. Regarding determination for restoration of communication on the first connection line L3, for example, when the voltage of the first connection line L3 has exceeded a second threshold voltage from a state of being equal to or smaller than the second threshold voltage, it is determined that communication is restored.

After determining that the vehicle 10 is started, the acquisition device 20 acquires the first vehicle information from the vehicle 10 every time a condition for acquiring the first vehicle information is satisfied. The condition for acquiring the first vehicle information is, for example, that a certain period elapses from when the first vehicle information has been acquired at the last time. The acquisition device 20 stores the acquired first vehicle information as second vehicle information in the first storage unit 23 such that the time information of the first clock unit 22B is associated therewith.

In addition, after determining that the vehicle 10 is started, the acquisition device 20 determines whether or not the acquisition device 20 is communication-connected with the portable terminal 40. If the acquisition device 20 determines that the acquisition device 20 is communication-connected with the portable terminal 40, the acquisition device 20 transmits the second vehicle information stored in the first storage unit 23, to the outside. The second vehicle information that is transmitted from the acquisition device 20 is transmitted to the server 30 via the portable terminal 40. The second vehicle information transmitted to the server 30 is accumulated in the third storage unit 36. The second vehicle information accumulated in the server 30 is provided in response to a request from an external terminal device.

In the portable terminal 40, when a start condition is satisfied, the application program 48A is executed by the control unit 41. The start condition may be that the portable terminal 40 receives a beacon signal transmitted from the first communication unit 24 of the acquisition device 20, or may be that a predetermined operation is performed on the portable terminal 40, or may be another condition. In a case where the application program 48A is executed by the control unit 41, the application program 48A may be executed in the foreground or in the background.

When a connection start condition is satisfied, the application program 48A causes the portable terminal 40 to perform operation of communication-connecting the second communication unit 42 with the first communication unit 24 of the acquisition device 20. The connection start condition may be, for example, that the application program 48A is activated on the basis of reception of a beacon signal from the first communication unit 24, or may be that a predetermined operation is performed on the portable terminal 40, or may be another condition. The communication-connection between the second communication unit 42 and the first communication unit 24 is so-called pairing.

When the second communication unit 42 is communication-connected with the first communication unit 24, the above predetermined condition is satisfied. Therefore, the application program 48A causes the portable terminal 40 to perform operation of transmitting the time information of the second clock unit 41B from the second communication unit 42 to the first communication unit 24. At this time, there is a possibility that the acquisition device 20 cannot acquire the time information of the second clock unit 41B by one time of transmission. Therefore, the application program 48A may cause the portable terminal 40 to perform operation of transmitting the time information of the second clock unit 41B from the second communication unit 42 to the first communication unit 24, a plurality of times (e.g., three times). The application program 48A may or may not confirm that the acquisition device 20 has acquired the time information of the second clock unit 41B.

When having acquired the time information of the second clock unit 41B, the acquisition device 20 corrects the time information of the first clock unit 22B on the basis of the acquired time information. In a case where the acquisition device 20 has acquired the first vehicle information from the vehicle 10 after correcting the time information of the first clock unit 22B, the acquisition device 20 stores the first vehicle information as the second vehicle information in association with the corrected time information. Then, the acquisition device 20 transmits the second vehicle information to the server 30 via the portable terminal 40.

### 1-3. Example of Effect of First Embodiment

The acquisition device 20 of the vehicle information management system 100 described above, acquires, every time the acquisition device 20 is communication-connected with the portable terminal 40, the time information of the second clock unit 41B from the portable terminal 40, and corrects the time information of the first clock unit 22B on the basis of the acquired time information. Thus, the acquisition device 20 can store the first vehicle information acquired from the vehicle 10, as the second vehicle information, in association with the corrected time information of the first clock unit 22B. Therefore, the vehicle information management system 100 can more accurately specify the time when the acquisition device 20 has acquired the first vehicle information.

### Other Embodiments

The present invention is not limited to the embodiment described above with reference to the drawings, and for example, embodiments as shown below are also included in the technical scope of the present invention. In addition, various features of the above embodiment and embodiments described below may be combined in any manner without contradicting each other.

In the above embodiment, the vehicle 10 is a gasoline engine vehicle using gasoline as fuel. However, the vehicle 10 may be an engine vehicle using fuel other than gasoline or may not be an engine vehicle. For example, the vehicle 10 may be an engine vehicle using hydrogen, liquefied petroleum gas, or the like as fuel, a hybrid vehicle, or an electric vehicle.

In the above embodiment, the predetermined condition is that “the first communication unit 24 is communication-connected with the second communication unit 42 a predetermined number of times”. However, another condition may be adopted. For example, the predetermined condition may be that “a predetermined period elapses” or that “the vehicle 10 is started a predetermined number of times”.

In the above embodiment, the portable terminal 40 performs determination for whether or not the predetermined condition is satisfied. However, the acquisition device 20 may perform the determination. In this case, when having determined that the predetermined condition is satisfied, the acquisition device 20 may make a request to the portable terminal 40 for the time information of the second clock unit 41B. Then, the portable terminal 40 may transmit the time information of the second clock unit 41B to the acquisition device 20 in response to the request from the acquisition device 20.

In the above embodiment, when the predetermined condition is satisfied, the acquisition device 20 acquires the time information of the second clock unit 41B and corrects the time information of the first clock unit 22B on the basis of the time information of the second clock unit 41B. However, another configuration may be adopted. For example, when the predetermined condition is satisfied, the acquisition device 20 may cause the reference time acquisition unit 41A of the portable terminal 40 to acquire the reference time information, and may correct the time information of the first clock unit 22B on the basis of the reference time information.

It should be understood that the embodiments disclosed herein are illustrative in all aspects and thus are not restrictive. The scope of the present invention is not limited to the embodiments disclosed herein, and is intended to include all modifications within a scope defined in the claims or a scope equivalent to the claims.

### DESCRIPTION OF REFERENCE NUMERALS

10: vehicle
20: acquisition device
20A: acquisition unit
22B: first clock unit
22C: correction unit
23: first storage unit (storage unit)
24: first communication unit
30: server
40: portable terminal
41A: reference time acquisition unit
41B: second clock unit
42: second communication unit
48A: application program (relay means)
100: vehicle information management system

1. A vehicle information management system comprising:
an acquisition device including
an acquisition unit configured to acquire first vehicle information indicating a state of a vehicle, from the vehicle,
a first clock unit,
a storage unit configured to store the first vehicle information acquired by the acquisition unit, as second vehicle information, in association with time information of the first clock unit, and
a first communication unit configured to transmit the second vehicle information stored in the storage unit, to outside;
a server; and
relay means provided in a portable terminal having a second communication unit, the relay means being configured to, when the second communication unit has acquired the second vehicle information transmitted by the first communication unit, cause the portable terminal to perform operation of transmitting the second vehicle information to the server, wherein
the portable terminal includes a reference time acquisition unit configured to acquire reference time information, and a second clock unit of which time information is corrected on the basis of the reference time information acquired by the reference time acquisition unit, and
the acquisition device includes a correction unit configured to, every time a predetermined condition set in advance is satisfied, in a state where the first communication unit is communication-connected with the second communication unit, acquire at least one of the reference time information acquired by the reference time acquisition unit and the time information of the second clock unit, and correct the time information of the first clock unit on the basis of acquired time information.
